(19) United States
(12) Patent Application Publication
(10) Pub. No.: US 2026/0155604 A1
(43) Pub. Date: Jun. 4, 2026

(54) ELECTRICAL CONNECTOR ASSEMBLY INCLUDING PLUG CONNECTOR AND SOCKET CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: TERRANCE F. LITTLE, Fullerton, CA (US)

(21) Appl. No.: 18/964,530

(22) Filed: Dec. 1, 2024

(51) Int. Cl. H01R 13/631; H01R 12/72

(52) U.S. Cl. CPC H01R 13/631; H01R 12/722

(57) ABSTRACT

An electrical connector assembly includes: a plug connector including a shell and a paddle card having a mating end and received in the shell, the lower surface of the mating end having plural conductive pads; a socket connector including an insulative body and plural conductive terminals held in the insulative body, each conductive terminal having a contact portion for matching with the corresponding conductive pad of the paddle card and a mounting portion for mounting on an external circuit board; and a guide mechanism, wherein the shell has a guide device cooperating with the guide mechanism to guide the plug to move obliquely downward when the plug connector is mated with the socket connector.

### BACKGROUND OF THE INVENTION

### Field of the Invention

The present invention relates generally to an electrical connector assembly, and particularly to an electrical connector assembly suitable for transmitting high-speed signals in communication infrastructure fields such as servers and switches.

### Description of Related Arts

U.S. Pat. No. 6,142,802 discloses an electrical connector assembly including a plug connector with a circuit board and a receptacle assembly mated with the plug connector, the plug connector has a pair of cam-follower projections, and the socket connector has a cam defined by two oppositely inclined ramps and forms indented portions shaped correspondingly to the ramps. When the plug connector and the socket connector are mating, the plug is guided to move upward first and then move downward, which is easy to get stuck.

U.S. Pat. No. 10,680,388 discloses an electrical assembly including a pluggable connector with a circuit board and a receptacle assembly mated with the pluggable connector, the pluggable connector includes guide features. A cage of the receptacle assembly includes guide tracks configured to receive the guide features of the pluggable module. The guide rails extends obliquely downward in the entire front-to-back direction of the cage, requiring the connector to leave a large space in the up and down direction.

An improved electrical connector assembly is desired.

### SUMMARY OF THE INVENTION

The objective of the present invention is to provide an electrical connector assembly to facilitate transmission of high-speed signals.

To achieve the above object, an electrical connector assembly comprises: a plug connector including a shell and a paddle card having a mating end and received in the shell, the lower surface of the mating end having a plurality of conductive pads; a socket connector including an insulative body and a plurality of conductive terminals held in the insulative body, each conductive terminal having a contact portion for matching with the corresponding conductive pad of the paddle card and a mounting portion for mounting on an external circuit board; and a guide mechanism, wherein the shell has a guide device cooperating with the guide mechanism to guide the plug to move obliquely downward when the plug connector is mated with the socket connector.

Compared to prior art, in the electrical connector assembly of the present invention, the guide device cooperates with the guide mechanism to guided the plug to move obliquely downward when the plug connector is mated with the socket connector.

### BRIEF DESCRIPTION OF THE DRAWING

FIG. 1 is a perspective view of an electrical connection system according to the present invention;

FIG. 2 is another perspective view of the electrical connection system of FIG. 1;

FIG. 3 is a perspective view of the plug connector and socket connector assembly of the electrical connection system of FIG. 1, before mating;

FIG. 4 is another perspective view the plug connector and socket connector assembly of the electrical connection system of FIG. 4, before mating;

FIG. 5 is an exploded view of the socket connector assembly and the external circuit board of the electrical connection system of FIG. 3;

FIG. 6 is an exploded view of the socket connector of FIG. 5;

FIG. 7 is another exploded view of the socket connector of FIG. 6;

FIG. 8 is another exploded view of the socket connector of FIG. 7;

FIG. 9 is a perspective view of the conductive terminal of the socket connector of FIG. 5;

FIG. 10 is a cross-sectional view taken along line A-A of the socket connector assembly of FIG. 6;

FIG. 11 is a cross-sectional view taken along line B-B of the electrical connector system of FIG. 1, wherein the plug connector and the socket connector are at the starting mating point; and

FIG. 12 is a cross-sectional view taken along line B-B of the electrical connector system of FIG. 1, wherein the plug connector are fully mated with the socket connector.

### DETAILED DESCRIPTION OF THE PREFERRED EMBODIMENT

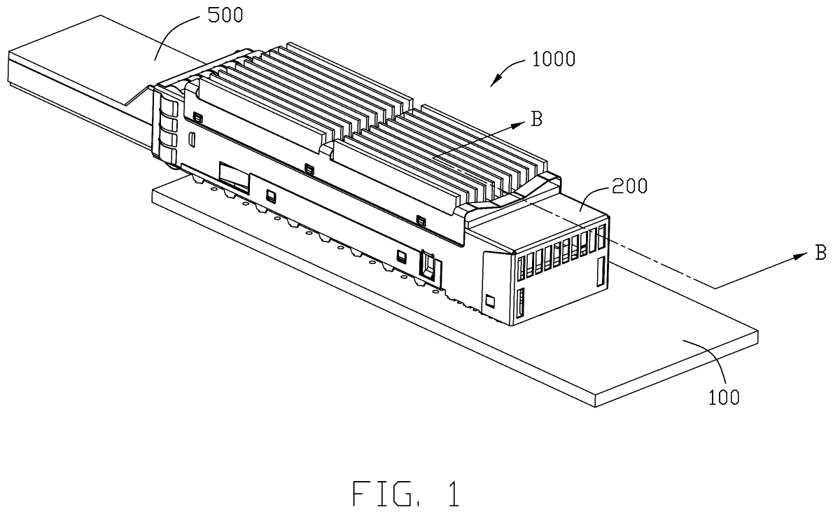

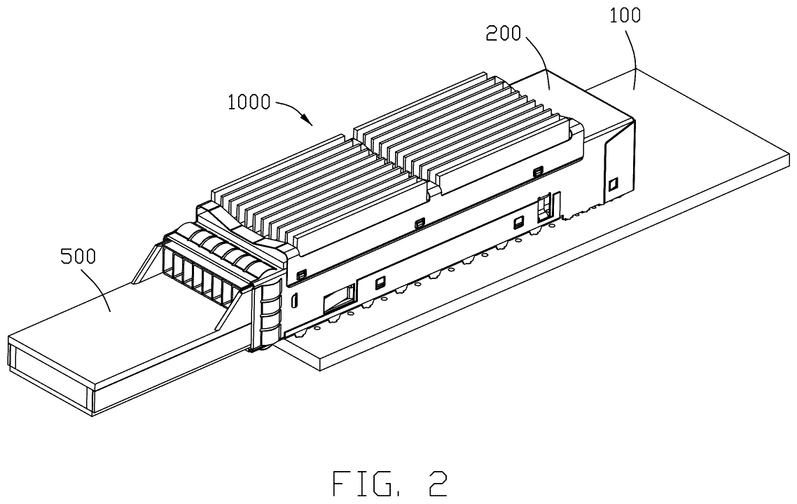

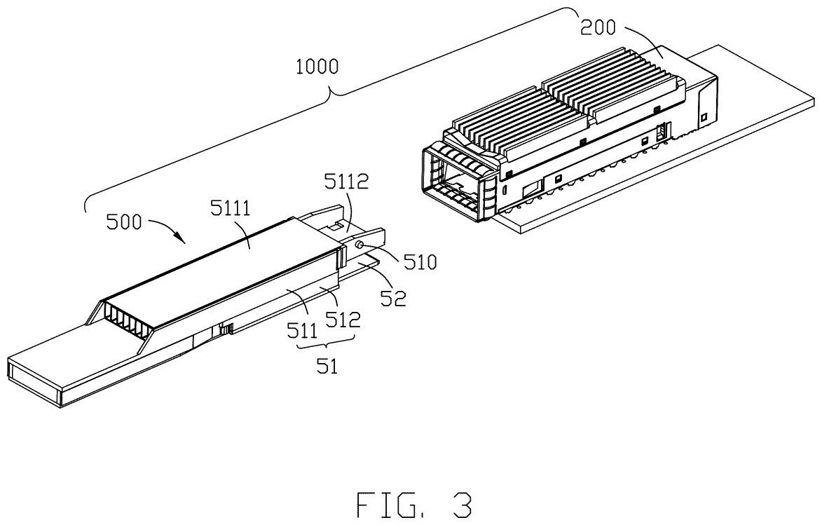

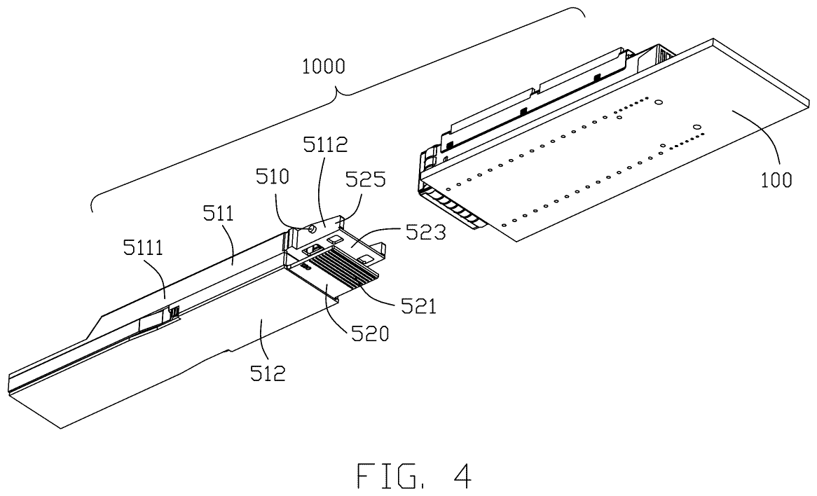

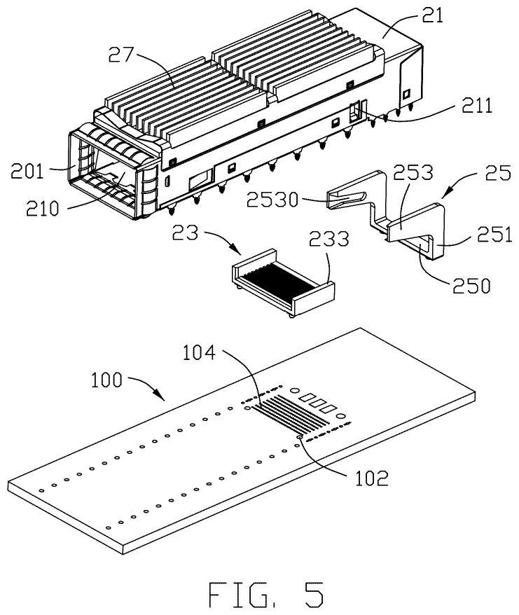

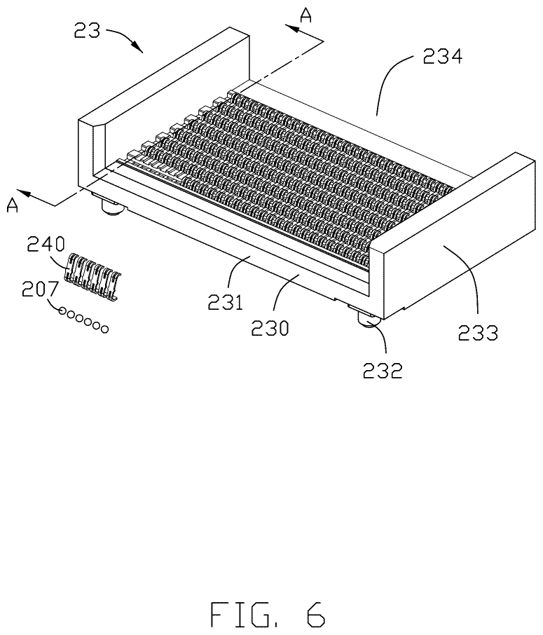

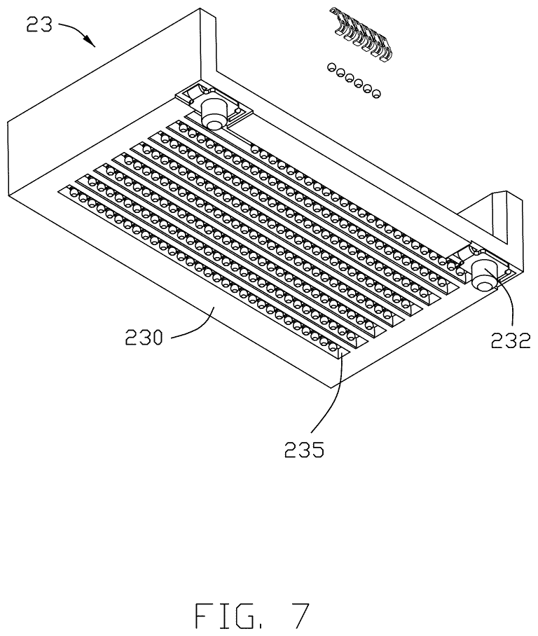

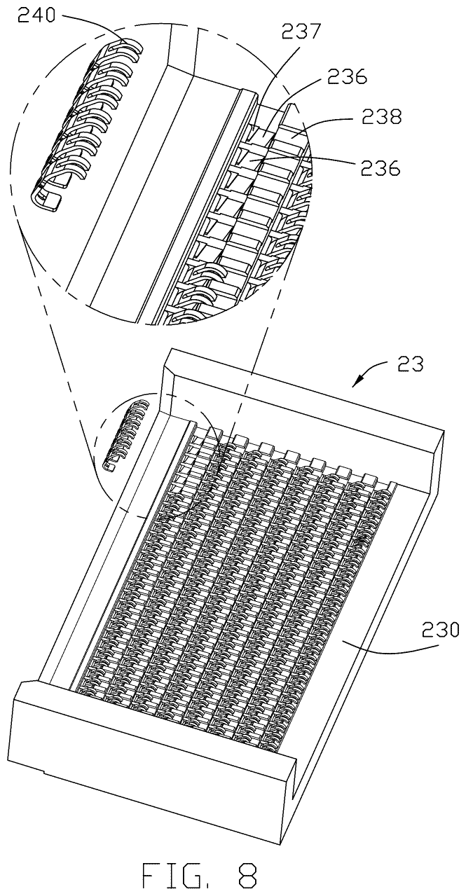

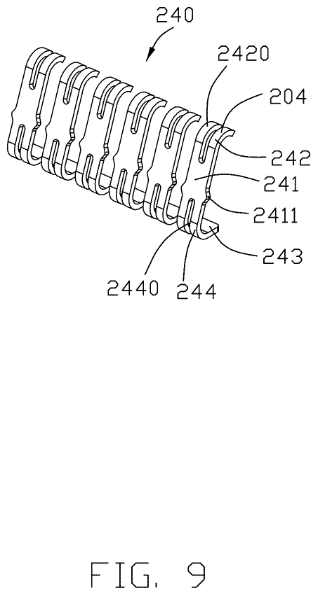

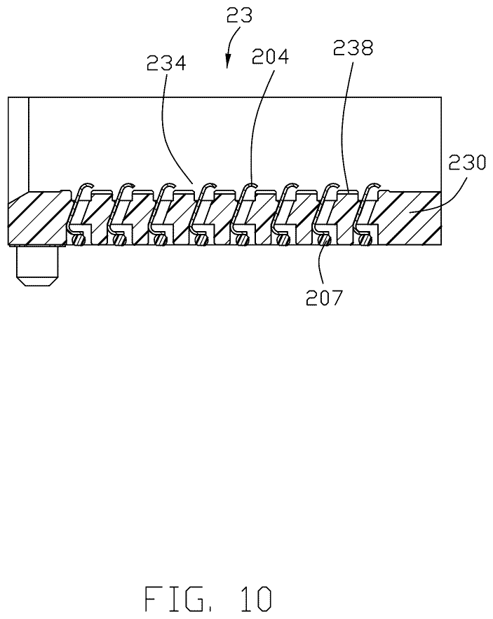

Referring to FIGS. 1-12, an electrical connection system 1000 in accordance with the present invention is shown. The electrical connection system 1000 includes an external circuit board 100, a socket connector assembly 200 that can be installed on the external circuit board 100, and a plug connector 500 that can be mated with the socket connector assembly 200. The transmission speed of the electrical connection system 1000 can reach 448Gbps or higher.

The socket connector assembly 200 includes a shielding cage 21, a socket connector 23 and a guide mechanism 25 housed in the shielding cage 21, and a heat dissipation device 27 provided on the shielding cage 21. The shielding cage 21 surrounds an accommodating space 210 with a front opening 201. The socket connector 23 is located at the rear of the accommodating space 210 and can be mounted downwardly on the external circuit board 100.

The plug connector 500 can be inserted through the front opening 201 to mate with the socket connector 23. The plug connector 500 is connected with the socket connector 23 along the front-to-back directions. For ease of understanding, for the plug connector 500, the end that is first inserted into the shielding cage 21 is defined as the front end, for the socket connector 23, the side close to the plug connector 500 is defined as the front side. The shielding cage 21 has a plug connector 500 stopping datum 211.

The plug connector 500 includes a shell 51 and a paddle card 52 received in the shell 51. The shell 51 includes an upper shell 511 and a lower shell 512 mated with the upper shell 511. The paddle card 52 is located between the upper and lower shells. The paddle card 52 includes a mating end 520 located at the front end. The lower surface of the mating end 520 has a plurality of conductive pads 521. The conductive pads are located only on the underside of the paddle card 52. The conductive pads 521 are arranged in an array. The mating end 520 extends forward beyond the lower shell 512 so that the conductive pad 522 is exposed downward. The upper shell 511 includes a main body portion 5111 and a mating portion 5112 in front of the main body portion 5111. The main body portion 5111 cooperates with the lower shell 512. The mating portion 5112 extends forward beyond the lower shell 512. The mating portion 5112 is located above the mating end 520 of the paddle card 52 and extends forward beyond the frontmost end of the mating end 520. The main body portion 5111 and the mating portion 5112 each include an upper wall 523 and two side walls 525 extending vertically from the two lateral sides of the upper wall 523. The distance between the two side walls 525 of the mating portion 5112 is smaller than the distance between the two side walls of the main body portion 5111. The shell 51 is provided with a guide device. The guide device is an outwardly protruding cam follower 510 provided on the two side walls 525 of the mating portion 5112.

The socket connector 23 includes an insulative body 230 and a plurality of conductive terminals 240 held in the insulative body 230. The insulative body 230 includes a bottom wall 231 and a pair of spaced apart side walls 233 extending upward from two ends of the bottom wall 231 in the transverse direction. The bottom wall 231 of the insulative body 230 has a guide post 232 extending downward, and the external circuit board 100 has a hole 102 matching the guide posts 232. The bottom wall 231 is parallel to the external circuit board 100. The bottom wall 231 and the two side walls 233 together form a receiving space 234 that communicates forward and upward with the accommodating space 210, so that the mating end 520 of the paddle card 52 can enter the receiving space 234 along the mating direction. The pair of side walls 233 of the insulative body 230 restricts the movement of the paddle card 52 in the left and right directions. The bottom of the bottom wall 231 has a plurality of grooves 235. Each of the grooves 235 extends in a transverse direction. The plurality of grooves 235 are parallel to each other and spaced apart along the front and rear direction. The groove 235 is recessed upward for a certain distance from the bottom surface of the bottom wall 231. Each groove 235 is provided with a plurality of terminal holes 236 penetrating through the bottom wall 231. The terminal holes 236 in each groove 235 are arranged in a row along the groove 235, and the corresponding terminal holes 236 in different grooves 235 are arranged in a column. Thus, the terminal holes 236 are arranged in a matrix on the bottom wall 231. Each of the terminal holes 236 is tilted backward from bottom to top. The plurality of conductive terminals 240 are respectively installed in corresponding terminal holes 236 so the conductive terminals are also arranged in a matrix. The socket connector has 8 rows of conductive terminals 240, with 30 conductive terminals 240 in each row. In other embodiments, the number of rows and columns of conductive terminals 240 is determined as needed.

The conductive terminal 240 is formed by punching and bending from a flat metal plate. Each conductive terminal 240 includes a holding portion 241 held on the bottom wall 231, an elastic arm 242 extending from one end of the holding portion 241, a mounting portion 243 disposed at the other end of the holding portion 241 opposite to the elastic arm 242, and a connecting portion 244 connecting the holding portion 241 and the mounting portion 243. The elastic arm 242 first extends upward and backward from the holding portion 241, and then bends downward. A contact portion 204 is formed at the highest point of the elastic arm 242. The holding portion 241 has barb 2411 protruding from each side in the transverse direction to fix the terminal on the bottom wall 231. The contact portion 204 protrudes upward beyond the upper surface of the bottom wall 231 of the insulative body 230. The contact portion 204 extends upward into the receiving space 234 for contacting the conductive pad 521 on the lower surface of the paddle card 52. The elastic arm 242 has a slot 2420. The slot 2420 extends to the end of the elastic arm 242 to form a bifurcated structure to facilitate stable connection. The connecting portion 244 also has a slit 2440. The mounting portion 243 is not provided with slits or slots. The mounting portion 243 is parallel to the external circuit board 100. The connecting portion 244 extends forward and downward from the holding portion 241, and then bends backward to connect to the mounting portion 243. The mounting portion 243 does not extend downward beyond the bottom surface of the insulative body 230, but is suspended in the groove 235. The groove 235 can provide a space for receiving the solder ball 207. The external circuit board 100 is provided with a plurality of conductive soldering pads 104. The conductive terminal 240 is connected to the corresponding conductive soldering pad 104 through the BGA. In other embodiments, the conductive terminal 240 can also be electrically connected to the external circuit board 100 through press-fit. The front portions of the side surface of the terminal hole 236 have recessed portions 237 that are recessed in the transverse direction. The conductive terminal 240 includes a wide side where the metal plate is located and a narrow side where the metal plate is torn. The narrow side is accommodated in the recess 237. The size of the recess 237 in the front-to-back direction gradually increases from bottom to top. The rear surface of the recess 237 may limit excessive rearward deformation of the elastic arm 242 of the conductive terminal 240. The upper surface of the bottom wall 231 has a recessed portion 238 at rear of the corresponding terminal hole 236.

The guide mechanism 25 is at rear of the socket connector 23 and is installed on the external circuit board 100. The guide mechanism 25 includes a straight portion 250 arranged parallel to the external circuit board 100, two wall portions 251 extending upward from two sides of the straight portion 250 in the transverse direction, and a pair of mating arm portions 253 extending forward from the two wall portions 252. The straight portion 250 is behind the socket connector 23 and can be soldered to the external circuit board 100. The pair of mating arm portions 253 are suspended above the side walls 233 of the insulative body 230. The mating arm portion 253 extends forward beyond the front end of the insulative body 230. The guide mechanism 25 is an integrated design. Each of the matching arm portions 253 has a cam track slot 2530. The cam track slot 2530 is provided on the inner side of the mating arm portion 253. The cam track slot 2530 extends downward and backward obliquely. The front part of the cam track slot 2530 is trumpet-shaped to facilitate the entry of the cam 510. The width of the guide mechanism 25 along the transverse direction is no greater than the width of the socket connector 23 along the transverse direction.

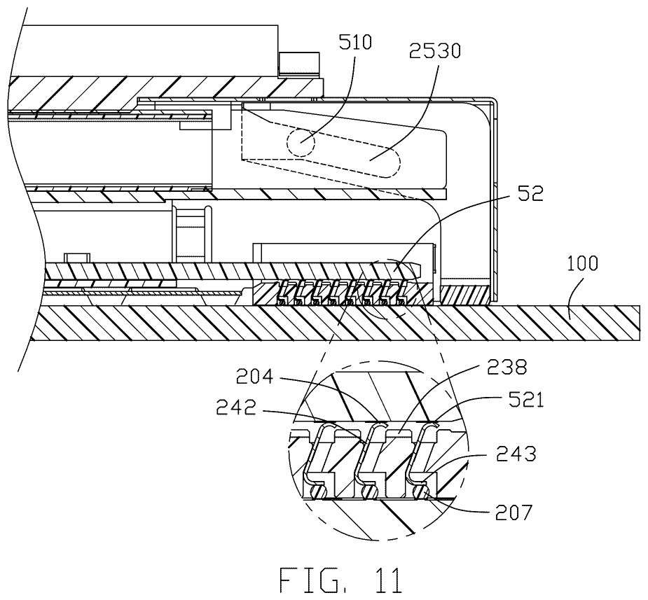

Referring to FIG. 11, as plug connector 500 or the module is inserted in the cage, the cam follower 510 engages with the cam track slot 2530 at the starting contact engagement point, at this time, the contact portion 204 of the conductive terminal 240 exceeds the bottom wall 231 and has not yet been deformed, the contact portion 204 is at the “beginning” of the conductive pads 521 of the paddle card 52, the contact portion 204 contacts the front area of the corresponding conductive pad 521.

As the plug connector 500 is inserted in the cage, the cam follower 510 continues to engage with the cam track slot 2530 and pushes the module and paddle card downward to deflect the conductive terminals 240. the contact portion 204 slightly slips on the conductive pad 521 of the paddle card 52, and the elastic arm 242 elastically deforms backward and downward.

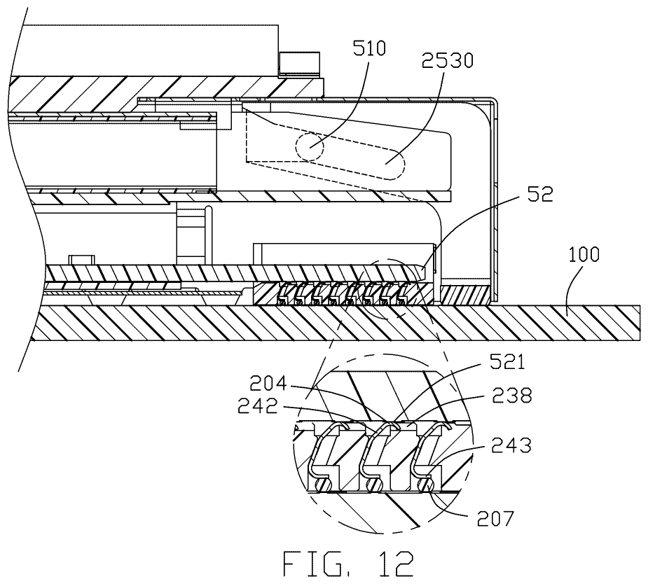

Referring to FIG. 12, show the plug connector 500 is inserted into a predetermined position and fully matched with the socket connector 23, the contact portion 204 is now at the “end” of the conductive pads 521 of the paddle card 52 and conductive terminals 240 are now deflected, the contact portion 204 of the conductive terminal 240 contacts the rear area of corresponding conductive pad 521. The front end of the contact portion 204 is received in the recessed portion 238.

In the electrical connection system 1000 of the present invention, the guide device cooperates with the guide mechanism 25 so that when the plug connector 500 is matched with the socket connector 23, the cam follower 510 of the plug connector 500 can engage with the cam track slot 2530, and push the plug connector downward to deflect the elastic arm 242 to realize the conductive pad 521 and the conductive terminal 240 cooperate. The transmission path of the conductive terminal 240 is shorter, and the wear on the conductive pad 521 of the circuit board 52 and the contact portion 204 of the conductive terminal 240 is smaller and lighter.

The electrical connection system 1000 of the present invention is another form of OSFP products, which defines eight transmitting channels and eight receiving channels, the signal transmission rate of each channel can reach 50 Gbps or above. Of course, the present invention can also be applied to high-speed electrical connector assembly such as SFP-DD, SFP, QSFP-DD, etc.

1. A plug connector comprising:
a shell including an upper shell and a lower shell; and
a paddle card received in the shell and having a mating end; wherein the mating end has a lower surface with a plurality of conductive pads, the upper shell includes a main body portion and a mating portion in front of the main body portion, the mating portion has a guide device at an outside thereof to move downward when mating with a socket connector.

2. The plug connector as claimed in claim 1, wherein the mating portion of upper shell extends beyond the paddle card in a mating direction, and the mating end of the paddle card extends beyond the lower shell in the mating direction.

3. The plug connector as claimed in claim 2, wherein the mating portion includes an upper wall and two side walls extending vertically from two sides of the upper wall, and the guide device includes an outwardly protruding guide cam follower provided on the two side walls.

4. The plug connector as claimed in claim 1, wherein the plurality of conductive pads are arranged in a matrix.

5. A socket connector assembly comprising:
a socket connector including:
an insulative body including a bottom wall and a pair of side walls extending upward from the two sides of the bottom wall in a transverse direction to form a receiving space that opens forward and upward for receiving a paddle card of a plug connector; and
a plurality of conductive terminals held in the insulative body and each including a holding portion fixed on the bottom wall, an elastic arm extending from one end of the holding portion into the receiving space for contacting the paddle card of the plug connector, and a mounting portion extending from the other end of the holding portion for mounting on an external circuit board; and
a guide mechanism for guiding the plug connector to move obliquely downward when the plug connector is mated with the socket connector.

6. The socket connector assembly as claimed in claim 5, wherein the guide mechanism includes a straight portion arranged parallel to the external circuit board, two side wall portions extending upward from two sides of the straight portion in the transverse direction, and a pair of mating arm portions extending forward from the two side wall portions, the straight portion is located at a rear of the insulative body, and the pair of mating arm portions are cantilevered above corresponding side walls of the insulative body.

7. The socket connector assembly as claimed in claim 6, wherein an inner side of each of the mating arm portions is provided with a cam track slot extending downwardly and backwardly.

8. The socket connector assembly as claimed in claim 6, wherein the guide mechanism is integrated, and a width of the guide mechanism along the transverse direction is not greater than a width of the socket connector along the transverse direction.

9. The socket connector assembly as claimed in claim 5, wherein the mounting portion is horizontally arranged with the external circuit board, the conductive terminal includes a connecting portion connecting the holding portion and the mounting portion, the connecting portion extends forward and downward from the holding portion and then bends backward to connect to the mounting portion, and the elastic arm first extends upward and backward from the holding portion and then bends downward, and the elastic arm has a slot.

10. The socket connector assembly as claimed in claim 9, wherein the bottom wall is provided with a plurality of terminal holes arranged in a matrix, each of the terminal holes extends obliquely backward from bottom to top, a front portion of the side surface of the terminal hole is provided with a recessed portion, and a size of the recess in the front-to-back direction gradually increases from bottom to top.

11. The socket connector assembly as claimed in claim 10, wherein a bottom surface of the bottom wall has a plurality of grooves extending in the transverse direction, the terminal hole communicates with the groove, and the mounting portion is suspended in the groove.

12. An electrical connector assembly comprising:
a plug connector including a shell and a paddle card having a mating end and received in the shell, the lower surface of the mating end having a plurality of conductive pads;
a socket connector including an insulative body and a plurality of conductive terminals held in the insulative body, each conductive terminal having a contact portion for matching with the corresponding conductive pad of the paddle card and a mounting portion for mounting on an external circuit board; and
a guide mechanism; wherein
the shell has a guide device cooperating with the guide mechanism to guide the plug to move obliquely downward when the plug connector is mated with the socket connector.

13. The electrical connector assembly as claimed in claim 12, wherein the guide mechanism includes a straight portion arranged parallel to the external circuit board, two side wall portions extending upward from two sides of the straight portion in the transverse direction, and a pair of mating arm portions extending forward from the two side wall portions, the inner side of the mating arm portions is provided with a cam track slot, the shell includes an upper shell and a lower shell, the upper shell includes a main body portion and a mating portion provided at a front of the main body portion, and the guide device includes a pair of outwardly protruding guide cam followers provided on the two side of the mating portion in the transverse direction.

14. The electrical connector assembly as claimed in claim 13, wherein the straight portion is located at the rear of the insulative body of the plug connector, and the pair of mating arm portions are cantilevered above the corresponding side walls of the insulative body.

15. The electrical connector assembly as claimed in claim 13, wherein the cam track slot extends rearwardly and downwardly, and the front part of the cam track slot is trumpet-shaped.

16. The electrical connector assembly as claimed in claim 12, wherein the conductive pads are located only on an underside of the mating end, and the mating end of the paddle card extends beyond the lower shell in a mating direction.

17. The electrical connector assembly as claimed in claim 16, wherein the insulative body includes a bottom wall and a pair of side walls extending upward from the two sides of the bottom wall in a transverse direction, the bottom wall and the pair of side wall together form a receiving space, and each of the conductive terminal includes a holding portion fixed on the bottom wall and an elastic arm having the contact portion and extending from the holding portion into the receiving space.

18. The electrical connector assembly as claimed in claim 17, wherein an upper surface of the bottom wall is provided with a recessed portion behind a corresponding terminal to provide space for the elastic arm to deform backward and downward.

19. The electrical connector assembly as claimed in claim 18, wherein the conductive terminals are combined with the external circuit board through a ball grid array.

20. The electrical connector assembly as claimed in claim 12, further including a shielding cage surrounding an accommodating space with a front opening, and wherein the socket connector and the guide mechanism are received at a rear of the accommodation space, the plug connector is insertable from the front opening, and the shielding cage has a stopping datum for stopping the plug connector.
